(19) United States
(12) Patent Application Publication
(10) Pub. No.: US 2007/0024693 A1
(43) Pub. Date: Feb. 1, 2007

(54) System and method for efficient donor material use

(75) Inventors: Gary W. Anderson, Spencerport, NY (US); Robert F. Mindler, Churchville, NY (US); Daniel W. Kuchta, Brockport, NY (US); John E. Wright, Henrietta, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/192,346

(22) Filed: Jul. 28, 2005

(51) Int. Cl. B41J 2/325

(52) U.S. Cl. 347/213

(57) ABSTRACT

Thermal printing systems, thermal printers and methods for printing are provided. A print order is received at a printer driving device. The printer driving device forms a set of page data streams. Each page data stream comprises image data representing one image from the print order in a format that can be used by a printer. The printer prints images by transferring donor material for patches of donor material from a donor ribbon onto a receiver medium. The printer is operable to print images in a manner that exhausts a full donor patch set or fractional donor patch set. Printing is performed using donor material from a fractional donor patch set when it is determined at the printer that an image from a page data stream can be printed using a fractional donor patch set and when it is determined that a fractional donor patch set is available for printing.

### CROSS REFERENCE TO RELATED APPLICATIONS

Reference is made to commonly assigned, co-pending patent applications U.S. Ser. No. 11/060,177 (Attorney Docket 89402), entitled SYSTEM AND METHOD FOR EFFICIENT DONOR MATERIAL USE, filed Feb. 17, 2005 in the names of Robert F. Mindler et al., and U.S. Ser. No. 11/060,178 (Attorney Docket 89,548), entitled SYSTEM AND METHOD FOR EFFICIENT DONOR MATERIAL USE, filed Feb. 17, 2005 in the name of Robert F. Mindler.

### FIELD OF THE INVENTION

The present invention relates to thermal printers that record images by transferring donor materials from a donor ribbon onto a receiver medium and methods for operating the same to improve the printing of the use of donor material.

### BACKGROUND OF THE INVENTION

In thermal printing, it is generally well known to render images by selectively heating and pressing one or more donor materials such as a dye, colorant or coating against a receiver medium. The donor materials are provided in sized donor patches on a movable web known as a donor ribbon. The donor patches are organized on the donor ribbon in donor patch sets. Each donor patch set contains all of the donor patches that are to be used to record an image on the receiver medium. For full color images, a donor patch set can use multiple patches of differently colored donor material, such as yellow, magenta and cyan donor dye patches. Arrangements of other color patches can be used in like fashion within a donor patch set. Additionally, each donor patch set can include an overcoat or sealant layer.

It will be appreciated from this that the size of the donor patches defines the full size of an image that can be printed using a conventional thermal printer. To provide flexibility of use, many thermal printers are capable of printing relatively large images such as 6″×8″ images. While prints of this size are highly desirable for many uses, it can be challenging to use and store images printed at this size. Accordingly, consumers often request that such printers render images at a fraction of the full size image, such as images printed at the wallet size, 3″×5″ size or 4″×6″ size. Images at these sizes are more easily used and stored while exhausting only a fraction of the donor material from a donor patch set leaving a fraction donor patch set.

Unfortunately, the printers of the prior art are not adapted to use the remaining donor material from a fractionally used donor patch set for printing other images. Instead, it is conventionally known to have a thermal printer advance to the next complete donor set after printing a fractional size image so that the thermal printer is prepared to print any size image when the next printing order is received. It will be appreciated that this results in inefficient use of the donor material causing increased printing expense. What is needed therefore is a thermal printer control system and a method that enables more efficient use of donor material.

Some thermal printer control systems incorporate external printer drivers that are executed on external processing devices such as personal computers to receive print requests from a user and to organize the print requests into “pages” that are fashioned so that they can be quickly processed and converted into a printed image by a printer controller. This has the advantage of lowering the cost of the thermal printer by moving expensive processing systems and memory systems from the thermal printer to the external device. However, such external processing devices do not always know whether a particular thermal printer has a fractional donor patch available for printing. Even where such information is available, the printer drivers in many of the most popular external devices are not easily reprogrammed to use such information. Thus, what is needed is a printer driver and printer controller system that enables more efficient use of donor material and that can do so without requiring costly changes to the printer or to the way in which the printer driver operates.

### BRIEF DESCRIPTION OF THE DRAWINGS

FIG. 1 shows a first embodiment of a printer driver and printer of the invention;

FIG. 2 shows one embodiment of a donor ribbon;

FIG. 3 shows a printhead, donor ribbon and receiver ribbon at a start of a first printing process for a first donor patch;

FIG. 4 shows a printhead, donor ribbon and receiver ribbon at a conclusion of a first printing process for a first donor patch;

FIG. 5 shows a flow diagram of a method for operating a printer in accordance with the invention;

FIG. 6 illustrates a thermal printing system and donor ribbon at the start of a first printing operation;

FIG. 7 illustrates the donor ribbon of FIG. 6 after the first printing operation;

FIG. 8 illustrates the donor ribbon of FIG. 6 at the start of a second printing operation; and

FIG. 9 illustrates the donor ribbon of FIG. 6 after the second printing operation.

### SUMMARY OF THE INVENTION

In one aspect of the invention, a method is provided for printing using a printer driving device and a thermal printer adapted to print images by transferring donor material from patches of donor material on a donor ribbon onto a receiver medium, the printer being operable to print images in a manner that exhausts a full donor patch set or a fractional donor patch set during printing. The method comprises the steps of: receiving, at the printer driving device, a print order requesting the printing of at least one image; processing the print order to form a set of page data streams, each page data stream comprising image data representing one image from the print order in a format that can be used by a printer. Each page data stream in the set is transmitted to the printer; and each page data stream is received at the printer. An image is printed based upon each received page data stream; wherein the printing is performed using donor material from a fractional donor patch set when it is determined at the printer that an image from a received page data stream can be printed using a fractional donor patch set and when it is determined that a fractional donor patch set is available for printing.

In another aspect of the invention, a thermal printing system is provided. A thermal printing system has a printer driving device having an input adapted to receive a print order requesting the printing of at least one image and a processor adapted to form a set of page data streams based upon the print order, each page data stream comprising data representing one image from the request in a format that can be used by the printer, and a communication circuit adapted to transmit each page data stream in the set to a printer. The printer has a printhead adapted to print images by transferring donor material from patches of donor material on a donor ribbon to form an image on a receiver medium The printer is operable to print images in a manner that exhausts a full donor patch set or in a manner that exhausts a fractional donor patch set during printing. The printer has a communication system adapted to receive signals from the external printer driving device and a controller adapted to receive each page data stream from the communication system and to print an image for each of the received page data streams. Wherein the controller causes donor material from a fractional donor patch set to be used to print an image from a received page data stream when it is determined that the image from the received page data stream can be printed using a fractional donor patch set and when it is also determined that a fractional donor patch set is available for said printing.

In yet another aspect of the invention, a thermal printer is provided. The thermal printer has a printhead adapted to print images by transferring donor material from donor patch sets onto a receiver medium, the printhead being operable to print images in a manner that exhausts a full donor patch set or a fractional donor patch set during printing, a translation system for selectively positioning the printhead and a receiver medium relative to each other during printing; and a receiver for receiving page data streams each having data representing one image to be printed, the image being in a format adapted for printing. A controller is adapted to cause the printhead and translation system to cooperate to print an image based upon a received page data stream using donor material from a fractional donor patch set where it is determined that an image from the received page data stream can be printed using a fractional donor patch set and where it is determined that a fractional donor patch set is available for printing.

### DETAILED DESCRIPTION OF THE INVENTION

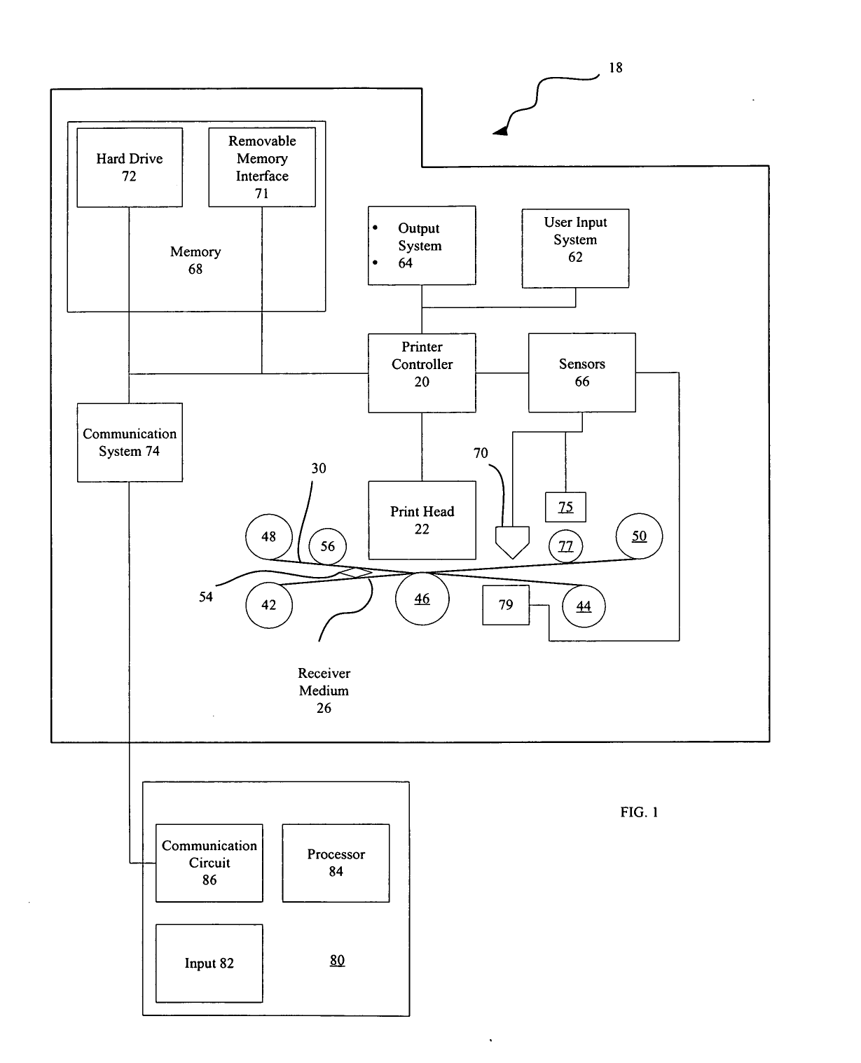

FIGS. 1-4 show a first embodiment of a printing system 16 of the invention. As is shown in FIG. 1, in this embodiment of the invention, a printer 18 is provided having a printer controller 20. Printer controller 20 causes a printhead 22 to record images on a receiver medium 26 by transferring material from a donor ribbon 30 to receiver medium 26. Printer controller 20 can include but is not limited to a programmable digital computer, a programmable microprocessor, a programmable logic controller, a series of electronic circuits or a series of electronic circuits reduced to the form of an integrated circuit, or a series of discrete components. In the embodiment of FIG. 1, printer controller 20 also controls a receiver medium take-up roller 42, a receiver medium supply roller 44, a donor ribbon take-up roller 48 and a donor ribbon supply roller 50, which are each motorized for rotation on command of the printer controller 20 to effect movement of receiver medium 26 and donor ribbon 30.

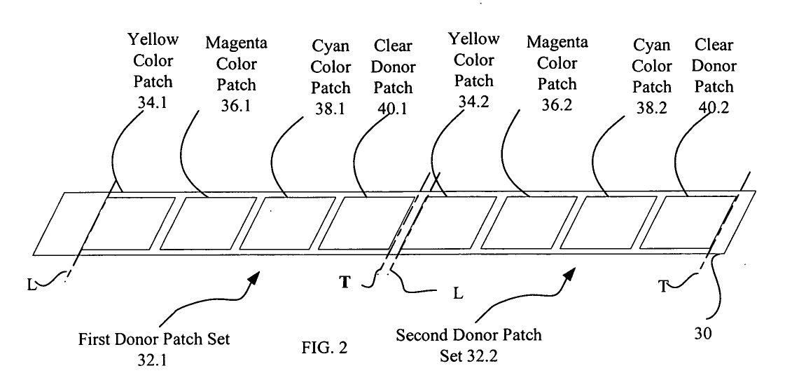

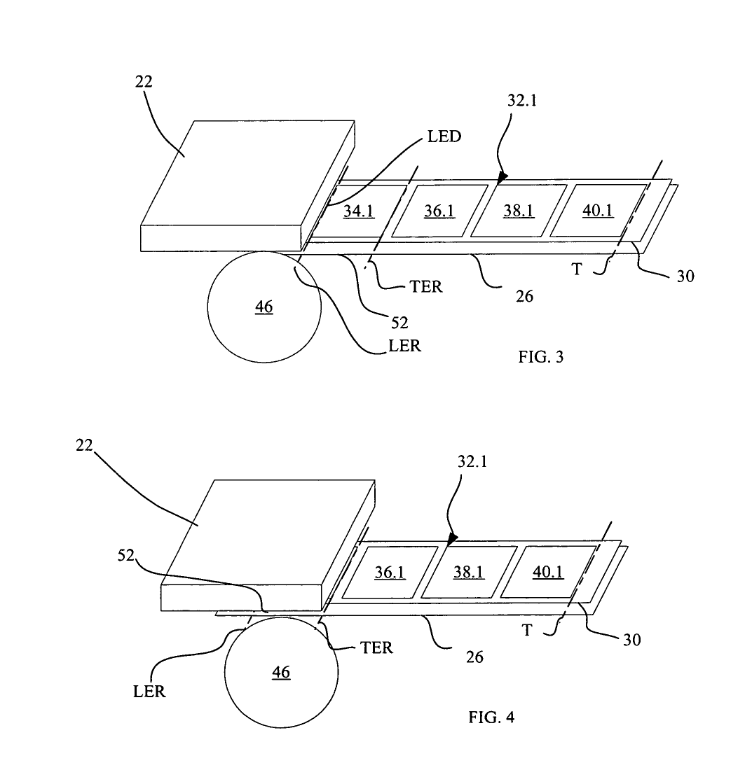

As is shown in FIG. 2, donor ribbon 30 comprises a first donor patch set 32.1 having a yellow donor patch 34.1, a magenta donor patch 36.1, a cyan donor patch 38.1 and a clear overcoat patch 40.1 and a second donor patch set 32.2 having a yellow donor patch 34.2, a magenta donor patch 36.2, a cyan donor patch 38.2 and a clear overcoat patch 40.2. Each donor patch set has a leading edge (L) and a trailing edge (T). In order to provide a full color image with a clear protective coating, the four patches of each set 32.1 and 32.2, etc. are printed, in registration with each other, onto a common image receiving area 52 of receiver medium 26 shown in FIG. 3.

A first color is printed by moving donor ribbon 30 in the conventional direction, from right to left with respect to printhead 22 as seen in FIGS. 1 and 3. During printing, printer controller 20 raises printhead 22 and actuates donor ribbon supply roller 50 and donor ribbon take-up roller 48 to advance a leading edge L of a first donor patch set 32.1 to printhead 22. In the embodiment illustrated in FIGS. 1-3, leading edge L for first donor patch set 32.1 is defined by at a leading edge of a yellow donor patch 34.1. The position of this leading edge L can be determined by using a donor position sensor 70 to detect a marking, indicia on donor ribbon 30 that has a known position relative to the leading edge of yellow donor patch 34.1 or by directly detecting leading edge of yellow donor patch 34.1 as will be discussed in greater detail below.

Printer controller 20 also actuates receiver medium take up roller 42 and receiver medium supply roller 44 so that image receiving area 52 of receiver medium 26 is positioned with respect to printhead 22. In the embodiment illustrated, the image receiving area 52 is defined by a leading edge LER and a trailing edge TER on receiver medium 26. When donor ribbon 30 and receiver medium 26 are positioned so that leading edge LED of yellow donor patch 34.1 is registered at printhead 22 with leading edge LER of image receiving area 52. Printer controller 20 then lowers printhead 22 so that a lower surface of donor ribbon 30 engages receiver medium 26 which is supported by platen roller 46.

Printer controller 20 then actuates receiver medium take-up roller 42, receiver medium supply roller 44, donor ribbon take-up roller 48 and donor ribbon supply roller 50 to move receiver medium 26 and donor ribbon 30 together past printhead 22. Printer controller 20 selectively operates heater elements (not shown) in printhead 22 to transfer donor material from yellow donor patch 34.1 to receiver medium 26. As donor ribbon 30 and receiver medium 26 leave the printhead 22, a stripping plate 54 separates donor ribbon 30 from receiver medium 26. Donor ribbon 30 continues over idler roller 56 toward the donor ribbon take-up roller 48. As shown in FIG. 4, after printing the trailing edge TER of image receiving area 52 of receiver medium 26 remains on platen roller 46. Printer controller 20 then adjusts the position of donor ribbon 30 and receiver medium 26 using a predefined pattern of donor ribbon movement so that a leading edge of each of the remaining donor patches 36.1, 38.1 and 40.1 in first donor patch set 32.1 are brought into alignment with leading edge LER of image receiving area 52 and the printing process is repeated to transfer further material as desired to complete image format.

Printer controller 20 operates the printer 18 based upon input signals from a user input system 62, sensors 66, a memory 68 and a communication system 74.

User input system 62 can comprise any form of transducer or other device capable of receiving an input from a user and converting this input into a form that can be used by printer controller 20. For example, user input system 62 can comprise a touch screen input, a touch pad input, a 4-way switch, a 6-way switch, an 8-way switch, a stylus system, a trackball system, a joystick system, a voice recognition system, a gesture recognition system or other such systems. An output system 64, such as a display, is optionally provided and can be used by printer controller 20 to provide human perceptible signals for feedback, informational or other purposes.

Sensors 66 can include light sensors and other sensors known in the art that can be used to detect conditions in the environment-surrounding printer 18 and to convert this information into a form that can be used by printer controller 20 in governing printing operation. In the embodiment of FIG. 1, sensors 66 include a donor position sensor 70 that is adapted to detect the position of donor ribbon 30 and a receiver medium position sensor 79. Printer controller 20 cooperates with donor position sensor 70 to monitor donor ribbon 30 during movement thereof so that printer controller 20 can detect one or more conditions on donor ribbon 30 that indicate a leading edge of a donor patch set. In this regard, donor ribbon 30 can be provided that has markings or other optically, magnetically or electronically sensible indicia between each donor patch set. Where such markings or indicia are provided, donor position sensor 70 senses these markings or indicia and provides signals to printer controller 20. Printer controller 20 can use these markings and indicia to determine when donor ribbon 30 is positioned with the leading edge L of a donor patch set or when any of the edges of any of the donor patches is at printhead 22. In a similar way, printer controller 20 can use signals from receiver medium position sensor 79 to monitor the position of receiver medium 26 to align receiver medium 26 during printing.

During a full image printing operation, printer controller 20 causes donor ribbon 30 to be advanced in a predetermined pattern of distances so as to cause a leading edge of each of the first donor patches 34.1, 36.1, 38.1 and 40.1 to be properly positioned relative to the image receiving area 52 at the start of each printing process. Printer controller 20 can be adapted to achieve such positioning by precise control of the movement of donor ribbon 30 using a stepper type motor for motorizing donor ribbon take up roller 48 or donor ribbon supply roller 50 or by using a movement sensor 75 that can detect movement of donor ribbon 30. In one example an arrangement using a movement sensor 75, a follower wheel 77 is provided that engages donor ribbon 30 and moves therewith. Follower wheel 77 can have surface features that are optically, magnetically or electronically sensed by movement sensor 75. One example of this is a follower wheel 77 that has markings thereon indicative of an extent of movement of donor ribbon 30 and a movement sensor 75 that has a light sensor that can sense light reflected by the markings. In other embodiments, perforations, cutouts or other routine and detectable indicia can be incorporated onto donor ribbon 30 in a manner that enables a movement sensor 75 to provide an indication of the extent of movement of the donor ribbon 30.

Alternatively, donor position sensor 70 can be adapted to sense the color of donor patches on donor ribbon 30 and can provide color signals to printer controller 20. In this alternative, printer controller 20 is programmed or otherwise adapted to detect a color that is known to be found in the first donor patch, e.g. yellow donor patch 34.1 in a donor patch set such as first donor patch set 32.1. When the first color is detected, printer controller 20 can determine that donor ribbon 30 is positioned proximate to the start of a donor patch set.

Data including, but not limited to, control programs, digital images and metadata can also be stored in memory 68. Memory 68 can take many forms and can include, without limitation, conventional memory devices including solid state, magnetic, optical or other data storage devices. In the embodiment of FIGS. 1-4, memory 68 is shown having a removable memory interface 71 for communicating with removable memory (not shown) such as a magnetic, optical or magnetic disks. In the embodiment of FIG. 1, memory 68 is also shown having an optional hard drive 72 that is fixed with printer 18.

In the embodiment shown in FIGS. 1-4, printer controller 20 has a communication system 74 for communicating external devices such as remote memory 76. Communication system 74 can be, for example, an optical, radio frequency circuit or transducer that converts electronic signals representing an image and other data into a form that can be conveyed to a separate device by way of an optical signal, radio frequency signal or other form of signal.

Printer controller 20 is operable to cause printing of differently sized images. In a full image mode, printer controller 20 prints images having image sizes that will exhaust most or all of the donor material in the donor patches of a donor patch set. In one example of this type, some images will be sized so that a single image will consume most or all of the donor material from an entire donor patch set. Likewise other combinations of images such as a request for a set of multiple wallet-sized prints will likewise consume substantially all of the donor material available in a single donor patch set. Printer controller 20 is also adapted to print images having various sizes that exhaust only a fraction of the donor material provided by a donor patch set and that leave a fractional donor set having donor patches with unused donor material that can be used to form what is referred to herein as a fractional size image.

Conventionally, such donor material is wasted as the conventional printer simply advances the donor ribbon 30 from first donor patch set 32.1 to second donor patch set 32.2 before initiating a next job. However, in the present invention, printer controller 20 is adapted to cooperate with a printer driving device 80 to operate in a novel mode that allows printer controller 20 to execute a first print order using a portion of donor material from a first donor patch set 32.1 and to further use remaining portions of the donor material from the first donor patch set 32.1 to render at least a second print.

In the embodiment of FIGS. 1-4, a printer driving device 80 is illustrated. Printer driving device 80 has an input 82 adapted to receive a print order requesting the printing of at least one image. Input 82 can comprise a manual user input for manually receiving a user input action and determining a print order at least in part based upon the user input action. Input 82 can also comprise a receiver for receiving a request from a remote source such as a telecommunication network, computer network or remote device such as a cellular telephone. For example, input 82 can include, but is not limited to, circuits and systems known to those of skill in the art for receiving entries made by way of user input action, or in response to a data provided by way of a memory (not shown) including, but not limited to, data provided by way of a removable memory (not shown).

When a print order is received from input 82, processor 84 analyzes the print order and forms a set of page data streams based upon the print order. Each page data stream comprises data representing one image from the print order in a format that can be used by printer 20 to cause one image from the print order to be printed. In this regard, processor 84 can be provided with printer driver software or custom application programming for use in forming the page data streams. Each page data stream is transmitted to printer 20. In the embodiment illustrated, the page data stream is transmitted by a signal sent by communication circuit 86 to communication system 74 of printer 18. A communication circuit 86 can also be used to receive print orders from remote sources and in that sense can also comprise input 82.

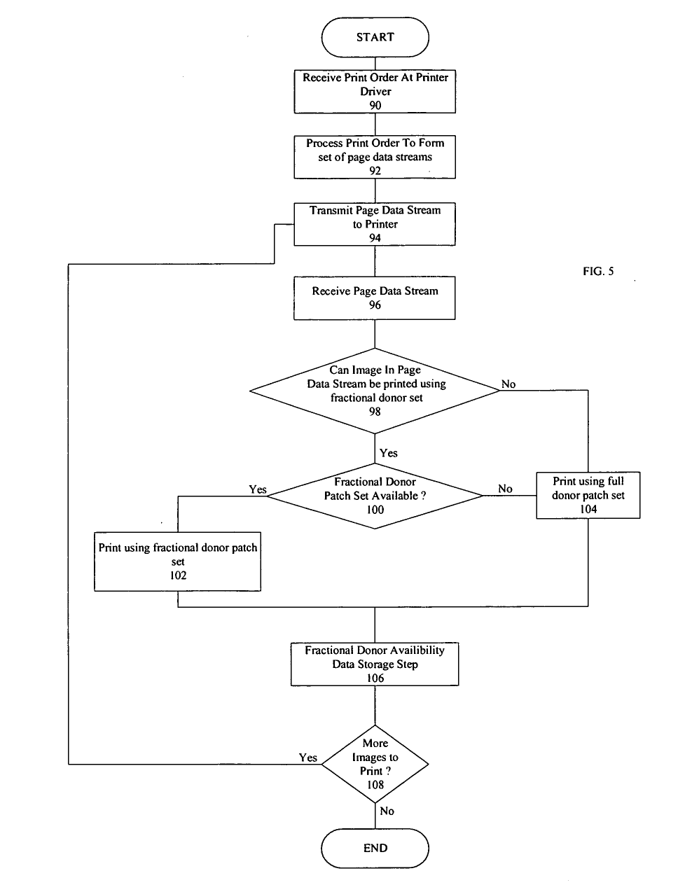

FIG. 5 provides a flow diagram showing one embodiment of a method for operating printer 18 in accordance with the invention. As shown in FIG. 5, printer driving device 80 receives a print order in any of the above described manners (step 90) and processes the print order to form a set of page data streams. Each page data stream comprises image data representing one image from the print order in a format that can be used by printer 18 to print one image (step 92). For example, a page data stream can take the form of image data to be provided to printer 18 in a manner that can be used by printer 18 to print an image. In certain embodiments, the page data stream can also include metadata that provides information that describes the way in which an image is to be printed. Such metadata can optionally include metadata from which it can be determined whether the received page data stream can be printed using a fractional donor patch set. It will be appreciated that other information can be included in the metadata. Each page data stream is then transmitted by communication circuit 82 (step 94) and is received by communication system 74 of printer 18 (step 96).

Printer controller 20 receives each page data stream from communication system 74 and determines whether the image requested can be printed using a fractional donor patch set (step 98). One way to determine whether the image from a page data stream can be printed using a fractional donor patch is to analyze the image data and to make the determination based at least in part upon the amount of image information to be printed. This determination can also be made using other forms of image analysis. Where the page data stream includes metadata from which it can be determined whether the image can be printed using a fractional donor patch set, such metadata can be used to make this determination. Examples of such metadata include, but are not limited to, image size metadata, or image format metadata.

Printer controller 20 then determines whether a fractional donor patch set is available for printing (step 100). This can be done in a variety of ways. In one embodiment, printer controller 20 is adapted to store data that indicates whether such a fractional donor patch set is available. In one embodiment this is done by maintaining a log indicating all print orders executed using donor ribbon 30. In this embodiment, printer controller 20 is adapted to analyze the log data to determine whether such a fractional donor patch set is available. Alternatively, printer controller 20 can be adapted to make a determination after each print as to whether a fractional donor patch set is available on donor ribbon 30 and to record a fractional data flag that indicates the availability or non-availability of a fractional donor patch set on donor ribbon 30 (step 106).

In certain embodiments of the invention, the log or flag data can be stored in memory 68 of printer 18. However, in other embodiments, the log or flag data can be stored in a memory that is physically associated with the donor ribbon 30. For example, donor ribbon 30 can be physically associated with a memory button of the type sold by Dallas Semiconductor, Dallas, Tex., USA or some other type of memory that printer controller 20 can exchange data with by way of a physical connection. Donor ribbon 30 can also be physically associated with a memory that is capable of exchanging data wirelessly with printer controller 20 and/or communication system 74. For example, a radio frequency identification tag can be used to store data and to provide data to printer 18 by way of an exchange of wireless signals with communication system 74.

Optionally, printer controller 20 can also determine characteristics such as the type and size of donor material 30 that remains in a donor patch set so that more refined determinations of the nature of the donor patch set that remains can be made. For the purposes of the discussion above, it has been assumed that printer controller 20 is adapted to cause images to be printed either using an entire donor patch or printed in a fractional mode that uses only one half of the donor material from each donor patch. However, this is done simply for convenience, and it will be appreciated that in other embodiments of the invention, fractional sized printing can involve other fractional sizes such as quarter size, wallet size, or the like. In this regard, printer controller 20 can optionally be adapted to determine the size of the donor material available in a fractional donor patch set from data stored in a memory such as a log or flag.

Where printer controller 20 determines that an image from a page data stream can be printed using a fractional donor patch and that a fractional donor patch is available, printer controller 20 will cause donor ribbon 30 to be positioned so that remaining portions of a fractional donor patch set are used in rendering the image (step 104).

Where printer controller 20 determines that the image from a page data stream cannot be printed using a fractional donor patch set, or where printer controller 20 determines that a fractional donor patch set is not available, printer controller 20 can cause a subsequent full donor patch set i.e., second donor patch set 32.2 to be used for printing the image (step 102).

Printer controller 20 can optionally record the location of a fractional donor patch e.g. first donor patch set 32.1 so that it can be used in a subsequent print order (step 90), or alternatively, printer controller 20 can ignore that fractional donor patch set but improve donor use efficiency by using donor material from other fractional donor patch sets (not shown) that arise during later printing operations. This latter embodiment allows inconveniently located fractional donor patch sets to be ignored so as to provide increased printer speed. This process is repeated for each image requested in the print order (step 108).

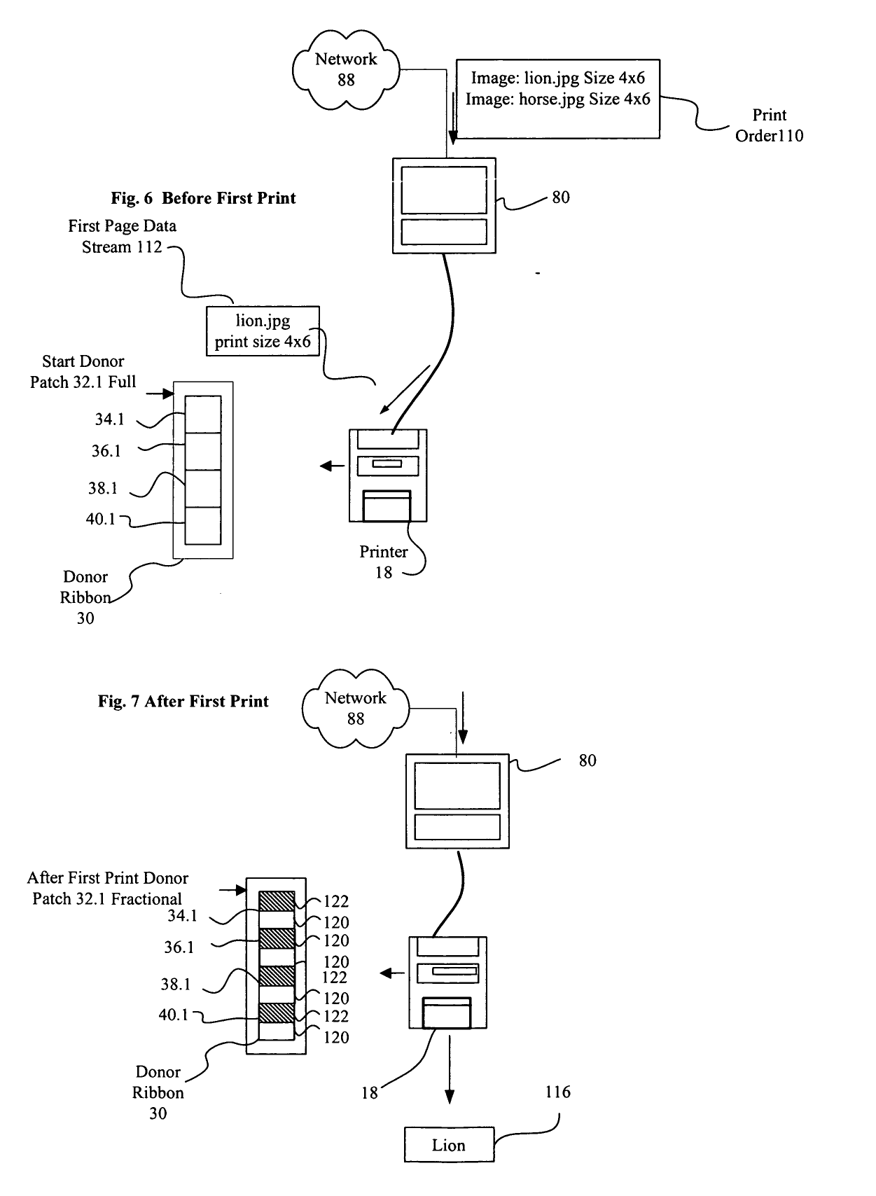

FIGS. 6-9 illustrate an example application of the embodiment of FIGS. 1-5 to a print order 110 requesting the printing of two images, each image requiring the use of a fractional donor patch set. In this example, a print order 110 is received from network 88 by input 82 of printer driving device 80 and provided to a processor 84 (step 90). In the embodiment of FIGS. 6-9 processor 84 then processes print order 110 by converting the print order 110 into a set of two page data streams 112 and 114 with a first page data stream 112 being used to define one of the images to be printed in the print order and a second page data stream 114 being used to define the other image in the print order (step 92). First page data stream 112 is then transmitted by communication circuit 86 of printer driving device 80 to printer 18 (step 94).

Communication system 74 of printer 18 receives the transmitted page data stream (step 96) and provides this to printer controller 20. Printer controller 20 then analyzes first page data stream 112 to determine whether the image in first page data stream 112 can be printed using a fractional donor patch set (step 98). In this example illustration, first page data stream 112 contains metadata, in this case print size metadata indicating that a 4″×6″ print is to be rendered. Accordingly, in this embodiment, printer controller 20 reads this print size metadata and determines from this that a first printed image 116 will consume only a fraction of the donor material available in donor patch set 32.1.

As illustrated in FIG. 6, when printer 18 is at an initial start-up point, donor ribbon 30 has a first donor patch set 32.1 available for full size printing. Printer controller 20 then causes a 4″×6″ image to be printed using half size fractions of 6″×8″ donor patches 34.1, 36.1, 38.1 and 40.1 of donor patch set 32.1. As is shown in FIG. 7, at the completion of printing first image 116 based upon first page data stream 112, first donor patch set 32.1 has donor patches 34.1, 36.1, 38.1 or 40.1 with half-patch size fractions 120 available for printing with half-patches 122 having been used for printing. In this embodiment, printer controller 20 stores a flag in memory 68 indicating that donor patch set 32.1 is available for printing a fractional size image.

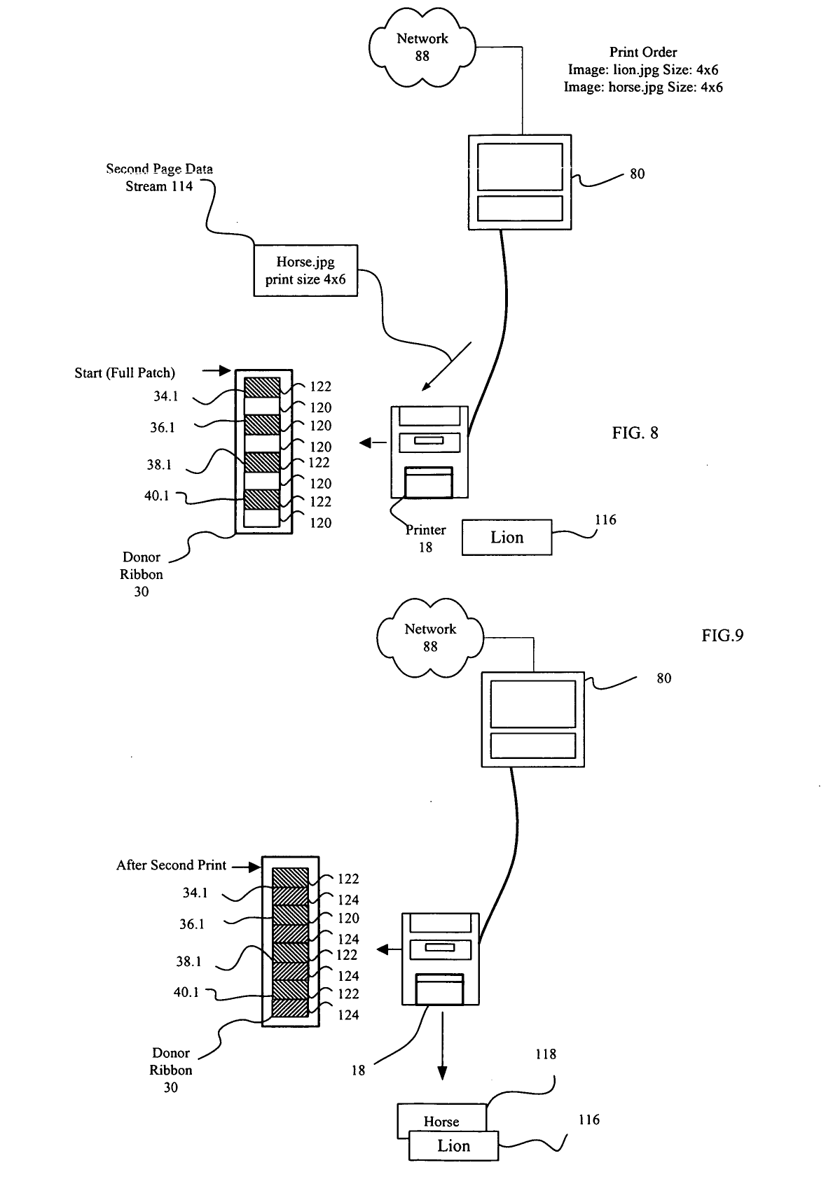

Printer driver 80 then causes communication circuit 86 to transmit a second page data stream 114 (steps 94 and 108). As shown in FIG. 8, communication system 74 receives second page data stream 114 and provides this to printer controller 20. Printer controller 20 determines whether the image to be printed in accordance with second page data stream 114 can be printed using a fractional donor patch set. Here, because second page data stream 114 contains metadata indicating that a 4″×6″ image is to be printed, printer controller 20 determines that the image of the second page data stream 114 can be printed using the remaining donor material.

Printer controller 20 then determines whether a fractional donor patch set is available for printing (step 100). In this embodiment, printer controller 20 does this by accessing the flag data stored in memory 68 which indicates that donor patch set 32.1 is now a fractional donor patch set that is available for printing. Accordingly, as shown in FIG. 9, printer controller 20 causes a second image 118 to be printed based upon the image contained in second page data stream 114 using the remaining fractions 120 of donor material from donor patch set 32.1.

It will be appreciated that, in order to use remaining fractions 120 of donor material from donor patch set 32.1 in printing second image 118, printer controller 20 must be capable of properly positioning donor patch set 32.1 so that printhead 22 confronts only remaining fractions 120 of donor patches 34.1, 36.1, 38.1 and 40.1 while printing second image 118. In the embodiment of FIGS. 1-5 and in the example of FIGS. 6-9 after the first print, printer controller 20 can optionally cause donor ribbon supply roller 50 and donor ribbon take up roller 48 to operate to move donor ribbon 30 from a position of donor ribbon 30 at the completion of the first print, to a position that aligns a remaining portion 120 of first donor patch set 34.1 with printhead 22 for subsequent printing, so that printing of a fractional size print in response to second page data stream 114 can be initiated immediately. Printer controller 20 can controllably position donor ribbon 30 so that fractions 120 of first donor patch set 32.1 can be used in printing a second print by causing donor ribbon take-up roller 48 and donor ribbon supply roller 50 to reverse the direction of donor ribbon movement after completing the first printing job and by using position sensor 70 to detect the start of first donor patch set 32.1 in the same manner as position sensor 70 can detect the start of first donor patch set 32.1 when donor ribbon 30 is advanced in a forward direction.

Once a donor ribbon 30 is positioned with printhead 22 at a leading edge L of donor patch set 32.1, printer controller 20 can determine a usable patch offset distance from the leading edge L of each patch and can use the offset distance to adjust the pattern of donor ribbon 30 movement so that only unused fractions 120 of each donor patch are used for printing. Printer controller 20 can determine the useable patch offset distance based upon the size of first image 116 and the overall size of the donor patches. For example, where donor patches 34.1, 36.1, 38.1 and 40.1 of first donor patch set 32.1 shown in FIG. 6-9 are each 6″×8″ patches and where print 116 was of 4″×6″ size, it can be determined that the first print order consumed the first four inches of each donor patch.

Accordingly, printer controller 20 determines a patch offset distance of four inches. As is illustrated in FIG. 7, when a subsequent print order is received that requires the printing of a 4″×6″ image, printer controller 20 causes donor ribbon 30 to be moved forward four inches from the start the first donor patch 34.1 in first donor patch set 32.1, and requires that printing begin at that point and continue only for another four inches. Printer controller 20 then moves donor ribbon 30 a distance that is equivalent to a full donor patch plus any inter-patch spacing so that printing of the second donor patch begins four inches from the start of the next donor patch, magenta donor patch 36.1. This process repeats for each donor patch, exhausting all of the remaining fractions 120 of donor patches 34.1, 36.1, 38.1, and 40.1 of first donor patch set 32.1.

In this way all remaining fractions 120 of first donor patch set 32.1 that were not used in rendering a first print order can be used to render at least a part of a second print order.

It will be appreciated that using this approach, a printer driving device 80 is provided that is adapted to organize and direct page data streams to printer controller 20 in a manner that allows printer controller 20 to determine whether to print an image using a fractional donor patch set without requiring that the printer controller 20 be necessarily adapted to receive print orders or to process print orders for printing.

The invention has been described in detail with particular reference to certain preferred embodiments thereof, but it will be understood that variations and modifications can be effected within the spirit and scope of the invention.

### Parts List

16 printing system
18 printer
20 printer controller
22 printhead
26 receiver medium
30 donor ribbon
32.1 first donor patch set
32.2 second donor patch set
34.1 yellow donor patch
34.2 yellow donor patch
36.1 magenta donor patch
36.2 magenta donor patch
38.1 cyan donor patch
38.2 cyan donor patch
40.1 clear overcoat patch
40.2 clear overcoat patch
42 receiver medium take-up roller
44 receiver medium supply roller
46 platen roller
48 donor ribbon take-up roller
50 donor ribbon supply roller
52 image receiving area
54 stripping plate
56 idler roller
62 user input system
64 output system
66 sensors
68 memory
70 donor position sensor
71 removable memory interface
72 hard drive
74 communication system
75 movement sensor
76 remote memory
77 follower wheel
79 receiver medium position sensor
80 printer driving device
82 input
84 processor
86 communication circuit
88 network
90 receive print order step
92 process print order to form set of page data streams step
94 transmit page data stream step
96 receiver page data stream step
98 image printed using fractional donor set determining step
100 fractional donor set available step
102 print using fractional donor patch set step
104 print using full donor patch set step
106 data flag/log step
108 more images for printing determining step
110 print order
112 page data stream
114 page data stream
116 first image
118 second image
120 unused fraction
122 unused fraction

1. A method for printing using a printer driving device and a thermal printer adapted to print images by transferring donor material from patches of donor material on a donor ribbon onto a receiver medium, said printer being operable to print images in a manner that exhausts a full donor patch set or a fractional donor patch set during printing, the method comprising the steps of:
receiving, at the printer driving device, a print order requesting the printing of at least one image;
processing the print order to form a set of page data streams, each page data stream comprising image data representing one image from the print order in a format that can be used by a printer;
transmitting each page data stream in the set to the printer;
receiving each page data stream at the printer; and
printing an image based upon each received page data stream;
wherein said printing is performed using donor material from a fractional donor patch set when it is determined that an image from a received page data stream can be printed using a fractional donor patch set and when it is determined that a fractional donor patch set is available for said printing.

2. The method of claim 1, further comprising the steps of storing data indicating whether a fractional donor patch set is available for printing and wherein the step of determining whether a fractional donor patch set is available for printing is performed based upon the stored data.

3. The method of claim 2, wherein the data is stored in a memory device that is physically associated with the donor ribbon and wherein the step of determining whether a fractional donor patch set is available for printing is performed based upon the stored data comprises establishing a wired or wireless communication path with the memory device, reading the stored data and using the stored data determine whether the fractional donor set is available.

4. The method of claim 1, wherein the step of processing the print order to form a set of individual page data streams further comprises encoding metadata in the page data stream from which it can be determined whether the received page data stream can be printed using a fractional donor patch set comprises analyzing metadata in the received page data stream and wherein such metadata is used to determine whether the received data stream can be printed using the fractional donor patch set.

5. The method of claim 1, wherein the step of determining whether the received data stream can be printed using a fractional donor patch set comprises the step of analyzing, at the printer, image data representing the image to be printed in accordance with the received paged data stream.

6. A thermal printing system comprising:
a printer driving device having an input adapted to receive a print order requesting the printing of at least one image and a processor adapted to form a set of page data streams based upon the print order, each page data stream comprising data representing one image from the request in a format that can be used by the printer, said communication circuit further being adapted to transmit each page data stream in the set to a printer; and
the printer having a printhead adapted to print images by transferring donor material from patches of donor material on a donor ribbon to form an image on a receiver medium, said printer being operable to print images in a manner that exhausts a full donor patch set or in a manner that exhausts a fractional donor patch set during printing, a communication system adapted to receive signals from the external printer driving device and a controller adapted to receive each page data stream from the communication system and to print an image for each of the received page data streams;
wherein said printer causes donor material from a fractional donor patch set to be used to print an image from a received page data stream when it is determined that the image from the received page data stream can be printed using a fractional donor patch set and when it is also determined that a fractional donor patch set is available for said printing.

7. The thermal printing system of claim 6, wherein the controller is adapted to store data in a memory indicating that a fractional donor patch is available for printing after printing in a manner that exhausts a fractional donor patch set.

8. The thermal printing system of claim 7, wherein said memory is physically associated with the donor medium, and further comprising a communication system that is adapted to exchange data with the memory.

9. The thermal printing system of claim 7, wherein said memory comprises a radio frequency transponder having a memory for storing data and wherein the communication system comprises a radio frequency transceiver that is adapted to exchange data with the memory in the radio frequency transponder using radio frequency signals.

10. The thermal printing system of claim 6, wherein said controller is adapted to cause the printhead to print an image using donor material from the fractional donor patch set by determining a position of a starting edge for each unused portion of each donor patch in the fractional donor patch set based upon a detected start of the donor patch set and based upon said stored data from which the size of an image previously printed using the available fractional donor patch can be determined.

11. The thermal printing system of claim 10, further comprising the step of determining an offset distance indicating a distance from the leading edge of each patch to which donor ribbon is to be advanced before printing an image using the available fractional donor patch.

12. The thermal printing system of claim 11, further comprising a position sensor adapted to determine a position of a start of a donor patch set and a donor movement sensor adapted to detect an extent of movement of the donor ribbon during transfer of donor material from the donor ribbon to the receiver medium, wherein said controller is adapted to transfer donor material from a fractional donor patch set by locating the start of the fractional donor patch set and using signals from the donor movement sensor to move the donor ribbon by the offset distance before printing.

13. A thermal printer comprising:
a printhead adapted to print images by transferring donor material from donor patch sets onto a receiver medium, the printhead being operable to print images in a manner that exhausts a full donor patch set or a fractional donor patch set during printing;
a translation system for selectively positioning the printhead and a receiver medium relative to each other during printing;
a receiver for receiving page data streams each having data representing one image to be printed, said image being in a format adapted for printing; and
a controller adapted to cause the printhead and translation system to cooperate to print an image based upon a received page data stream using donor material from a fractional donor patch set where it is determined that an image from the received page data stream can be printed using a fractional donor patch set and where it is determined that a fractional donor patch set is available for printing.
